(19) United States
(12) Patent Application Publication
(10) Pub. No.: US 2026/0356071 A1
(43) Pub. Date: Nov. 12, 2026

(54) SEALING OF CUT EDGES OF HOLLOW ARTICLES THAT ARE OPEN AT BOTH ENDS

(71) Applicant: ENVICAN GMBH, Sennhof (CH)

(72) Inventors: Christoph SCHOENIG, Sennhof (CH); Mario DIAZ, Sennhof (CH); Jorge RESTREPO, Weisskirchen an der Traun (AT)

(73) Assignee: ENVICAN GMBH, Sennhof (CH)

(21) Appl. No.: 19/137,146

(22) PCT Filed: Dec. 14, 2023
(86) PCT No.: PCT/EP2023/085846

§ 371 Date: Jun. 9, 2025

(30) Foreign Application Priority Data
Dec. 14, 2022 (AT) A 60201/2022

(51) Int. Cl. B31F 1/00; B31F 7/00

(52) U.S. Cl. CPC B31F 1/0093; B31F 7/002; B31F 7/006

(57) ABSTRACT

A method and device for sealing cut edges of hollow articles that are open at both ends with a sleeve present on the outside of the hollow article.

### CROSS-REFERENCE TO RELATED APPLICATIONS

The present application is a national phase application of PCT Application No. PCT/EP2023/085846, filed Dec. 14, 2023, entitled “SEALING OF CUT EDGES OF HOLLOW ARTICLES THAT ARE OPEN AT BOTH ENDS”, which claims the benefit of Austrian Patent Application No. A 60201/2022, filed Dec. 14, 2022, each of which is incorporated by reference in its entirety.

### BACKGROUND OF THE INVENTION

### 1. Field of the Invention

The invention relates to a method and device for sealing cut edges of hollow articles that are open at both ends using a sleeve on the outside of the hollow article.

### 2. Description of the Related Art

The hollow article open at both ends may be provided with one sealing element at each of its two ends to form a can and it may contain a medium. The sealing elements are present in the shape of a bottom and a lid, as known from cans, for example beverage cans, in the shape of aluminium cans or compound material cans.

The hollow article open at both ends is present as a section of a continuous tube made of multiple layers, wherein the innermost layer is a tight barrier layer. At least one other layer of the hollow article is made of a non-fluid-tight material, in particular paper, paperboard or cardboard. The barrier layer prevents a liquid or moisture from reaching the other layer from inside the hollow article.

When cutting off the hollow article that is open at both ends, the two cut edges of the other layer are exposed.

It is known in prior art to install sleeves on packaging articles, in particular plastic articles such as PET bottles. It includes a stretchable sleeve being pulled over the packaging article and contacting the jacket surface of the packaging article. Depending on the installing principle, a distinction is made between shrink sleeves and stretch sleeves, wherein the shrink sleeves are shrunk onto the packaging article under heating action and the stretch sleeves contract just by their elastic properties and attach themselves to the jacket surface.

A can as well as a method for manufacturing a can are known from the applicant's WO2022219176A1, wherein sealing the cut edges of the can is in a variant embodiment done by a sleeve which is pulled over the hollow article open at both ends in the shape of the can jacket. It has already been disclosed in WO2022219176A1 that the sleeve may be present in the shape of a stretch sleeve and that the sleeve may be folded inwards and connected to the interior barrier layer of the hollow article. It has also been disclosed that the hollow article may already have outwardly bulged end regions. A bulged end region is understood to mean a radial bulge of the jacket at the open end of the hollow article.

### SUMMARY OF THE INVENTION

It is a task of the invention to provide a method and device to be able to install the sleeve on the inside of the hollow article, in particular in a continuous process.

To solve said task, a method of installing an exterior sleeve on the inside of a hollow article open at both ends is proposed in a variant embodiment.

To solve the task, a device for installing an exterior sleeve on the inside of a hollow article open at both ends is proposed in a variant embodiment.

In a variant embodiment of an inventive method a stretchable sleeve is in a first step installed on the hollow article, surmounting the hollow article at both ends. Preferably, the hollow article is already present with bulged edges. This is understood to mean an outwardly deformed edge region, in particular an end region running outwards alongside a radius.

As a machine for placing the sleeve on the hollow article, a known device from prior art for installing sleeves to packaging articles may be used, in particular a device for installing stretch sleeves.

However, a difference from the known method is that the sleeve is installed on a hollow article open at both ends and that the sleeve is longer than the hollow article, so that the sleeve surmounts both cut edges of the hollow article.

Due to said surmounting and the use of elastic foil as the sleeve material, which contracts after being installed, the overlapping edges of the sleeve protrude into the respective opening substantially in planes defined by the opening edges at the two opposite open ends of the hollow article (also referred to herein as protruding inward obliquely or approximately perpendicularly (or vertically)) from the hollow article's jacket surface. This result of the first step thus constitutes a difference from the prior art.

The second step of the inventive method is that, at the cut edges of the hollow article open at both ends, the region of the sleeve protruding inwards is inwardly pressed onto, and tightly connected to, the barrier layer. This is preferably done by welding the sleeve and the barrier layer together under heating action.

Said heating action may be by the heated surface of an article which presses the inwardly protruding regions of the sleeve onto the barrier layer.

In a variant embodiment, the heating action may be by hot air. In a variant embodiment, the heating action may be by compressed, hot air, with the inwardly protruding regions of the sleeve being pressed onto the barrier layer by the compressed air.

In other variant embodiments, the heating action may be by ultrasound or by induction. In other variant embodiments, the heating action may be by laser. In another variant embodiment, the heating action may be by heat irradiation. In another variant embodiment, the heating action may be by infrared light.

When the welding is done or supported by a laser, it is preferably provided that the sleeve be pressed onto the barrier layer by a transparent pressing element, in particular a transparent stamp, with at least one laser beam reaching the region to be welded through the transparent pressing element.

The said methods of welding may be employed at either end or both ends of the hollow article. Multiple methods may also be used in combination, wherein two or more power sources may act at the same time or first one power source is used, followed by a second, different power source. This way, initial pre-welding may be done using the first power source and the welding may subsequently be completed using a second power source. In a variant embodiment, the two welding steps differ in the type, level or presence of a counterpressure on the outside of the hollow article and/or in the type or presence of a pressing element on the inside of the hollow article, or in its pressing pressure.

In another variant embodiment, an adhesive may be employed in connecting the sleeve to the barrier layer. The adhesive may be applied to the inwardly protruding region of the sleeve or to the barrier layer.

In a variant embodiment, the adhesive may be an adhesive that can be activated by heat. In another variant embodiment, the adhesive may be an adhesive that can be activated by light, in particular UV light.

Installing the inwardly protruding regions of the sleeve on the inside of the barrier layer may be done identically at both ends of the hollow article or by mutually different methods selected from the methods stated herein.

In a variant embodiment, it is provided that the sleeve or the hollow article be heated prior to installing the sleeve to the barrier layer. In a variant embodiment, it is provided that the sleeve and the hollow article be heated prior to installing the sleeve to the barrier layer. Such heating occurs or begins already before the inwardly protruding region of the sleeve is pressed onto the inside of the barrier layer of the hollow article.

It is preferred that connecting the inwardly protruding regions of the sleeve to the barrier layer is already done at the plant for placing the sleeve or subsequent thereto. In known plants for placing the sleeve, the packaging articles are continuously moved alongside a line and/or through a carousel. A mechanical device for stretching and pulling over the sleeve may be moved together with the packaging articles over a partial region.

Preferably, the machine for placing the sleeve is followed by an inventive station for connecting the projecting regions of the sleeve to the barrier layer. Preferably, the two projecting regions are simultaneously pressed onto the opposite openings of the hollow article, i.e. connected to the barrier layer. In another variant embodiment, the two opposite openings are processed sequentially. In this case, the hollow article may be turned after the sleeve and the barrier layer are connected on the first side, or the hollow article may be transferred from a first holder to a second holder.

In another variant embodiment, it is provided that, after connecting the sleeve and the barrier layer at the first end, a first sealing element be installed on said first end and the sleeve and the barrier layer are subsequently connected at the second end. The first sealing element installed may be the bottom or lid of a can.

After the sleeve and the barrier layer have been connected at the second end, the hollow article, which is now sealed at one end, may be filled and a second sealing element may then be installed on the second end. Connecting the sleeve and the barrier layer at the second end may also be done simultaneously or overlapping with the filling process.

Filling may be immediately adjacent to the station for sealing the first end of the hollow article at the same location. Alternatively, the hollow articles may be transported to a filling plant after the two cut edges have been sealed or after the first open end has been sealed.

Either or each of the two sealing elements may be installed on the hollow article in a pre-heated state.

Preferably, the inwardly projecting regions of the sleeve are pressed onto the barrier layer by a pressing element, which is vertically moved towards the opening surface until it contacts the inside of the outwardly bulged edge region of the hollow article.

Preferably, during this process, the hollow article is kept immediately beneath the outward bulge by a holding element. The holding element creates the required counterpressure on the outside of the outward bulge to prevent it from being deformed or damaged while the pressing element is pressed on.

Preferably, one holding element is present at each of the two ends of the hollow article. Alternatively, one holding element may be present and extend across the height of the hollow article to apply a counterpressure to both outwardly bulged hollow article edges.

The holding element may be made of a dimensionally stable material such as metal or plastic. In a variant embodiment, the holding element has an elastic surface, in particular made of rubber, silicone or another elastic material.

In a variant embodiment, the holding element comprises an inflatable or pumpable article or an article that is expandable in a different manner, which contacts the hollow article, in particular its outwardly bulged hollow article edge. The inflatable or pumpable article may be a ring, which in a non-expanded state may be moved over the outside of the outwardly bulged hollow article edge while expanding the ring causes a reduction of its interior diameter.

In another variant embodiment, the hollow article is held from the inside.

Preferably, the hollow article is held by a predefined layer of the sleeve's side seam and/or a thicker area of the hollow article's jacket. In a variant embodiment, a holding element may have a recess for the sleeve's side seam and/or a recess to receive a thicker area of the hollow article present on the outside of the jacket. In a variant embodiment, a holding element on the inside of the hollow article may have a recess for a thicker area of the hollow article present on the inside of the jacket. In a variant embodiment, a pressing element which presses the inwardly protruding region of the sleeve against the barrier layer, may have a recess to receive the sleeve's side seam and/or a recess to receive a thicker area of the jacket.

Preferably, the plant comprises a carousel or line, wherein multiple pressing units comprising pressing elements and holding elements run together with the hollow articles moved alongside the carousel or line.

In a variant embodiment, the hollow articles may also stand still when the sleeve is pressed on by the pressing elements, wherein preferably multiple pressing elements are simultaneously pressed onto multiple hollow articles that are standing still. This may be done by stopping the conveying device for the hollow articles for this process or by removing the hollow articles from a continuously moved conveying device for this process and placing them back on the continuously moved conveying device after the process.

This procedure with hollow articles standing still that are processed in groups may be referred to as a batch process.

In another variant embodiment, the inwardly protruding regions of the sleeve are only connected to the barrier layer when placing sealing elements. The sealing elements are preferably present a can lids and can bottoms. When placing a sealing element, the edge region of the sealing element is placed on the outwardly bulged hollow article edge and the two edge regions are crimped together. By said crimping, the edge region of the sealing element and the edge region of the hollow article are mechanically pressed together to create a tight connection. Said mechanical crimping presses the inwardly protruding region of the sleeve onto the barrier layer. In a variant embodiment, this mechanical connection of the sleeve to the barrier layer by crimping the sealing element is the only one.

In variant embodiments, either or both of the two sealing elements may be installed on the hollow article in a pre-heated state.

In another variant embodiment, additional welding of the sleeve to the barrier layer is performed. This may be by installing a heated sealing element or by subsequent heating action, for example by ultrasound, induction, heat irradiation, hot air or laser.

If the sealing element has a plastic coating on its inside, this coating may also be welded to the sleeve.

A variant embodiment of the invention consists in a method of installing a sleeve on the outside of a hollow article that is open at both ends, wherein the hollow article is held from its inside while the sleeve is being installed, wherein the sleeve is longer than the hollow article and surmounts the hollow article at both ends of the hollow article after having been installed.

A variant embodiment of the invention consists in a device for installing a sleeve on the outside of a hollow article that is open at both ends, wherein a holding device protrudes onto the inside of the hollow article and contacts the inside of the hollow article, wherein the hollow article is present at the holding device in a predefined length position and with a predefined orientation.

A variant embodiment of the invention consists in a method in which in a first step, a sleeve is installed on the outside of a hollow article that is open at both ends, wherein the sleeve surmounts the hollow article at both ends of the hollow article after having been installed, and in a second step, the projecting regions of the sleeve are fastened to the inside of the hollow article. The first step may be done with methods and devices known in prior art.

A variant embodiment relates to a method of placing one elastic sleeve on each hollow article open at both ends, which sleeve is longer than the distance between the two opposite ends of the hollow article and which sleeve has a has a smaller perimeter in an unstretched state than the hollow article has at its open ends, wherein the hollow articles open at both ends are held from the inside within a machine for installing the sleeve, wherein the respective sleeve is stretched by spreading action at least at its end facing the hollow article and placed over the same in the longitudinal direction of the respective hollow article until the sleeve surmounts the jacket surface of the hollow article in a longitudinal direction of the hollow article at both open ends, wherein the spreading action is subsequently removed, whereupon the two edges of the sleeve which surmount the hollow article protrude inwards obliquely or vertically from the opening edge of the hollow article, wherein the two edges of the inwardly protruding sleeve are subsequently pressed onto the interior surface of, and connected to, the hollow article.

It is preferred in this method that the respective hollow article is cylindrical and has at both open ends an outwardly bulged edge region, in particular two opposite edge regions running outwards alongside a radius between which a cylindrical jacket section of the hollow article extends.

It is preferred in this method that the interior jacket surface of the respective hollow article is formed by a barrier material which extends across the height of the hollow article up to the two opening edges and in that the exterior jacket surface of the hollow article is made of paper or cardboard material.

It is preferred in this method that multiple hollow articles are simultaneously moved through the machine for installing the sleeves, wherein each hollow article is present on a holding element which contacts the jacket surface of the hollow article on the inside, wherein, after installing the sleeve, the hollow articles are transported further on the holding element to a device which presses one or both of the edges of the inwardly protruding sleeve onto the interior surface of the hollow article.

It is preferred in this method that before or while the edges of the inwardly protruding sleeve are pressed onto the interior surface of the hollow article, heating action is performed on the sleeve and the interior jacket surface of the respective hollow article, wherein the sleeve and the interior jacket surface are made of plastic and welded together.

In a variant embodiment of the method, it is provided that pressing at least one of the two edges of the inwardly protruding sleeve be done by installing a sealing element which seals an opening of the hollow article.

It is preferred that the respective hollow article is supported from the inside by a holding element across its cylindrical interior jacket region while the sleeve is being installed.

It is preferred that the respective hollow article is supported from the inside by a holding element in at least one edge region of the outwardly bulged hollow article while the sleeve is being installed.

It is preferred in this method that stretching the sleeve is done by multiple spreading elements which protrude onto the inside of the sleeve, wherein the spreading elements contact the sleeve on the inside across a length thereof which equals at least half the length of the hollow article, wherein the multiple spreading elements are present between the sleeve and the hollow article while the sleeve is placed and wherein they are extracted from between the hollow article and the sleeve when the sleeve is at its desired position on the hollow article.

It is preferred in this method that, while at least one of the two edges of the sleeve protruding inwards is pressed onto the interior surface of the hollow article and connected, a counterpressure is applied on the outside of the hollow article, in particular on an edge region of the outwardly bulged hollow article.

Specifically, it is preferred that the counterpressure is applied by a holder which encompasses the hollow article.

Specifically, it is preferred that the counterpressure is applied by an expandable, in particular inflatable or pumpable, element which contacts the exterior edge region of the hollow article only in an expanded state.

It is preferred that installing the sleeve to the hollow article is done at controlled orientation, so that a thicker area of the jacket of the hollow article and a thicker area of the sleeve lie in different perimeter regions.

It is preferred that pressing at least one of the two edges of the sleeve protruding inwards onto the interior surface of the hollow article is done using a transparent stamp and in that a laser beam is directed onto the regions of the sleeve and the interior surface of the hollow article to be connected through the transparent stamp.

A variant embodiment relates to a device for installing an exterior sleeve on the inside of a hollow article open at both sides, wherein the sleeve is placed over the respective hollow article in a longitudinal direction thereof, wherein the sleeve surmounts the jacket surface of the hollow article at both open ends in a longitudinal direction of the hollow article, wherein the two edges of the sleeve which surmount the hollow article preferably protrude inwards obliquely or vertically from the opening edge of the hollow article, wherein the device comprises holding devices or holders each for holding one open hollow article, and wherein the device comprises pressing elements for pressing the sleeve onto the inside of the hollow article at at least one end of the open hollow article, wherein a relative movement between the pressing elements and the holding elements or holders can be executed through the device.

It is preferred that the device comprises means for welding the sleeve to the inside of the hollow article that is open at both ends.

It is preferred that the device comprises means for applying a counterpressure onto the outside of the hollow article opposite the pressing elements.

Preferably, the sleeve has been placed on the hollow article according to the methods described herein before it reaches the said device for installing an exterior sleeve on the inside of each hollow article open at both ends.

Less preferably, the sleeve may have also been placed in a different manner, as long as it encloses the hollow article on its outside and surmounts it at both open ends.

Preferably, the sleeve is a stretch sleeve. Less preferably, it may also be a shrink sleeve.

### BRIEF DESCRIPTION OF THE DRAWINGS

The invention will now be additionally explained based on the following embodiments depicted in the figures:

FIG. 1 schematically illustrates a device for fastening an exterior sleeve to the inside of a hollow article open at both ends in an opened state.

FIG. 2 schematically illustrates a device for fastening an exterior sleeve to the inside of a hollow article open at both ends in a closed state.

FIG. 3 schematically illustrates the procedure of receiving a hollow article open at both ends in a first exemplary holder.

FIG. 4 schematically illustrates the procedure of inserting the first exemplary holder with the hollow article open at both ends present thereon into a sleeve.

FIG. 5 schematically illustrates the first exemplary holder with the hollow article open at both ends present thereon within the sleeve.

FIG. 6 schematically illustrates a device for fastening the sleeve on the inside of the hollow article comprising the first exemplary holder of FIGS. 3 to 5.

FIG. 7 schematically illustrates the procedure of receiving a hollow article open at both ends in a second exemplary holder.

FIG. 8 schematically illustrates combining the second exemplary holder with a loosely present element prior to inserting the second exemplary holder with the hollow article open at both ends present thereon into a sleeve.

FIG. 9 schematically illustrates the procedure of inserting the second exemplary holder with the hollow article open at both ends present thereon into a sleeve.

FIG. 10 schematically illustrates the second exemplary holder with the hollow article open at both ends present thereon within the sleeve.

FIG. 11 schematically illustrates device for fastening the sleeve on the inside of the hollow article comprising the second exemplary holder of FIGS. 7 to 10.

FIG. 12 shows another variant for installing the sleeve.

FIGS. 13 and 14 illustrate internal holders of the hollow article when connecting the sleeve to the barrier layer.

FIG. 15 shows a variant for connecting the sleeve to the barrier layer by sealing the hollow article with a sealing element.

FIG. 16 illustrates the offset arrangement of a thicker area of the hollow article's jacket and a thicker area of the sleeve.

### DETAILED DESCRIPTION

These figures are pictorial schematics not to scale.

The embodiments in the figures merely show possible embodiments, however, it should be noted that the invention is not limited to these specifically shown variant embodiments thereof, but that combinations among the individual variant embodiments as well as combinations of one embodiment with the above general description are possible. Such other possible combinations do not need to be expressly mentioned, since these other possible combinations lie within the knowledge of a person of skill in the relevant art based on the technical teaching of the present invention.

The scope of protection is defined by the claims. However, the description and the drawings are to be used in interpreting the claims. Individual features or combinations of features from the various embodiments shown and described may represent distinct inventive solutions in themselves. The object underlying such distinct inventive solutions may be taken from the description.

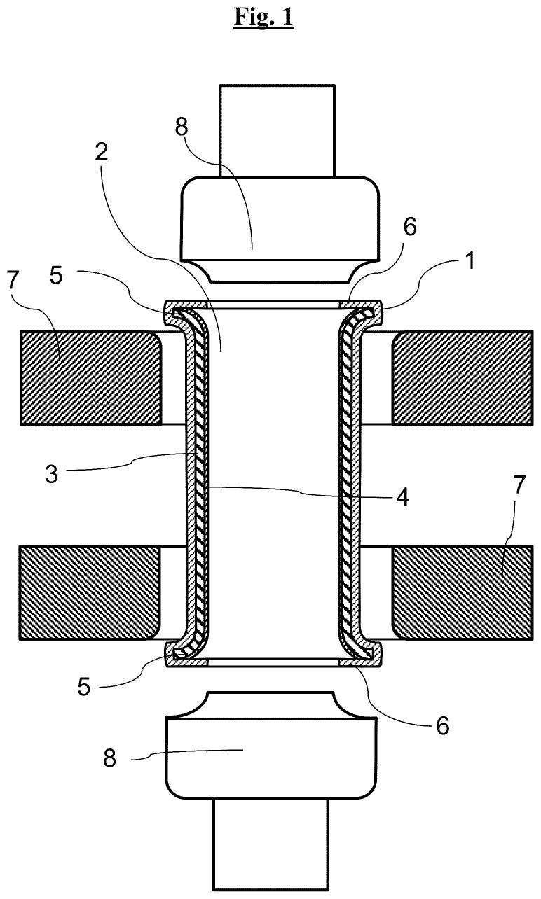

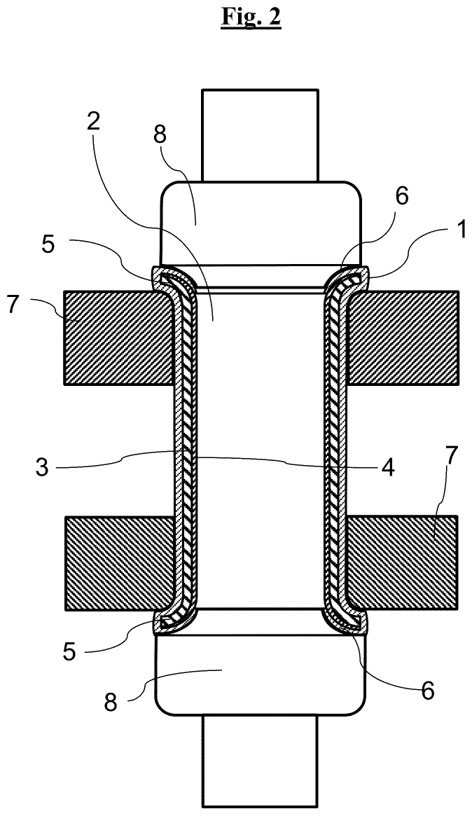

FIGS. 1 and 2 illustrate a device for fastening an outside sleeve 1 on the inside of a hollow article 2 open at both ends. The hollow article 2 comprises a multi-layered jacket comprising at least one exterior layer 3 made of absorbent and/or non-liquid-resistant material. Preferably, the hollow article 2 comprises multiple such exterior layers 3.

On its inside, the hollow article 2 has a barrier layer 4 which is liquid-tight. The barrier layer 4 is in particular tight with respect to the contents of the finished packaging article. The barrier layer 4 forms a closed interior wall of the hollow article 2.

To create hollow articles 2, first the multiple layers are preferably fabricated into a continuous tube by winding. Subsequently, individual hollow articles 2 are cut from the continuous tube, so that the exterior layer 3 or the multiple exterior layers 3 are exposed on the cut edges of the hollow articles 2.

After separating the individual hollow articles 2, their respective edge regions are bulged outwards, i.e. provided with an edge region that is radially widened towards the outside. The bulge 5 is preferably present as a radius.

The exterior layer 3, i.e. the outermost of multiple layers 3 of the hollow article 2, may be made of absorbent and/or non-liquid-resistant material on its outside.

The exterior layer 3 or each of multiple exterior layers 3 is preferably made of cardboard, paperboard or paper. Kraft paper is preferred.

In FIGS. 1 and 2, an exterior sleeve 1 is already present around the hollow article 2. The sleeve 1 may be pulled over the hollow article 2 using a machine for installing stretch sleeves, or the hollow article may be pushed into the sleeve 1 using a machine for installing stretch sleeves. Such machines are generally known in prior art.

Most importantly for the present invention, though, the sleeve 1 is made longer than the hollow article 2, wherein the sleeve 1 surmounts both cut edges of the hollow article 2. There is thus a projecting region 6 of each sleeve 1.

Said projecting region 6 is shown to run vertical to the longitudinal direction of the hollow article 2, but may also protrude obliquely inwards.

It is a task of the device to press the projecting region 6 inwards onto the barrier layer 4 and to fasten them there.

A variant embodiment of a machine for fastening the projecting regions of the sleeve 1 comprises at least one holder 7 for each hollow article 2 moved through the machine simultaneously. As shown, two holder 7 may be present per hollow article 2, one for each end region.

In a variant embodiment, the holder 7 may start at the center of the hollow article 2 and press the sleeve 1 onto the center of the hollow article 2. The holders 7 are then driven apart up to the edges of the hollow article 2. This facilitates the removal of air which may be present between the hollow article 2 and the sleeve 1. It also allows for the sleeve 1 to contact the hollow article 2 with a better fit, should the elastic reset forces be insufficient. In a less preferred variant embodiment, the holders 7 may be heated to cause the sleeve 1 to shrink on. However, use of a stretch sleeve is preferred.

Preferably, the holders 7 encompass the perimeter of the hollow article 2 on either of the end regions. As shown, the holders 7 may have radii which are formed so as to correspond to the bulge 5. Alternatively, the holders 7 may also hold the hollow article 2 closely spaced apart from the bulge 5.

Preferably, each hollow article 2 is gripped by a holder 7 (i.e. by two holders 7) once it reaches the machine and then moved through the machine by said holder 7 (or holders 7) until the hollow article 2 is removed from the machine or handed over to another machine.

Once the hollow article 2 is held in the holder 7, the two pressing elements 8 may be transferred into the two open ends of the hollow article 2 to make them press the projecting regions 6 of the sleeve 1 onto the barrier layer 4. Preferably, the projecting regions 6 contact exclusively the bulge 5 and thus do not protrude all the way to the vertical region of the interior hollow article wall.

Preferably, the pressing elements 8 have a surface shape in the region of the bulge 5 which corresponds to the shape of the bulge 5. The surface shape may have a recess for a thicker area 21 of the sleeve 1. The surface shape may have a recess for a thicker area of the hollow article 2.

By making the pressing elements 8 and preferably also the holders 7 correspond the shape of the bulge 5 facing it, the shape of the bulge 5 is maintained while the projecting regions 6 are installed.

When the projecting regions 6 are connected, in particular melded or caulked, to the barrier layer 4, the pressing elements 8 may be moved out the hollow article 2 and the hollow article 2 may be removed from the holders 7 or transferred from the holders 7 to another part of the plant.

The pressing elements 8 are preferably moved through the machines together with the holders 7 and the hollow article 2.

Instead of a pressing element 8 which presses the projecting region 6 onto the entire perimeter at the same time, less preferably, a rotating or pivoting pressing element may be used, which presses the projecting region 6 while running around the entire perimeter starting from one or multiple points.

Preferably, a plurality of devices, each comprising one or two holders 7 and two pressing elements 8, is arranged on a carousel, wherein hollow articles 2 are moved along on a subregion of the carousel's perimeter.

Less preferably, many devices, each comprising one or two holders 7 and two pressing elements 8, may be moved alongside a line and moved back to the beginning of said line once a hollow article 2 has been released on the end of the line.

Less preferably, the holders 7 and pressing elements 8 may be moved together with the hollow articles 2 independently of each other.

Alternatively, multiple devices, each comprising one or two holders 7 and two pressing elements 8, may each be stationary on a transport route (carousel or line) for hollow articles 2, wherein, in a staggered manner, each device removes a hollow article 2 from the line and hands it over to another line upon completing the installment.

A machine for installing a sealing element may follow the machine for installing the projecting regions 6 at either of the two ends of the hollow article 2. The sealing element is preferably placed over the bulge 5 and rolled into a bulge therewith. The bulge 5 and hence also the projecting region 6 fastened to the barrier layer 4 are thus included in the bulge of the sealing element and thereby mechanically crimped. The hollow article 2 may then be filled from the end that is still open and subsequently sealed in an equal fashion using a second sealing element. Since at least the filling of the hollow article and the placement of the second sealing element are done in a moist environment, it is important to have the cut edge protected by the sleeve 1.

After the machine for installing the projecting regions 6 and/or the placement of the first sealing element, intermediate storage of the hollow articles 2 may also take place until they are taken to be filled.

The sleeve 1 and/or the exterior layer 3 may exhibit some print.

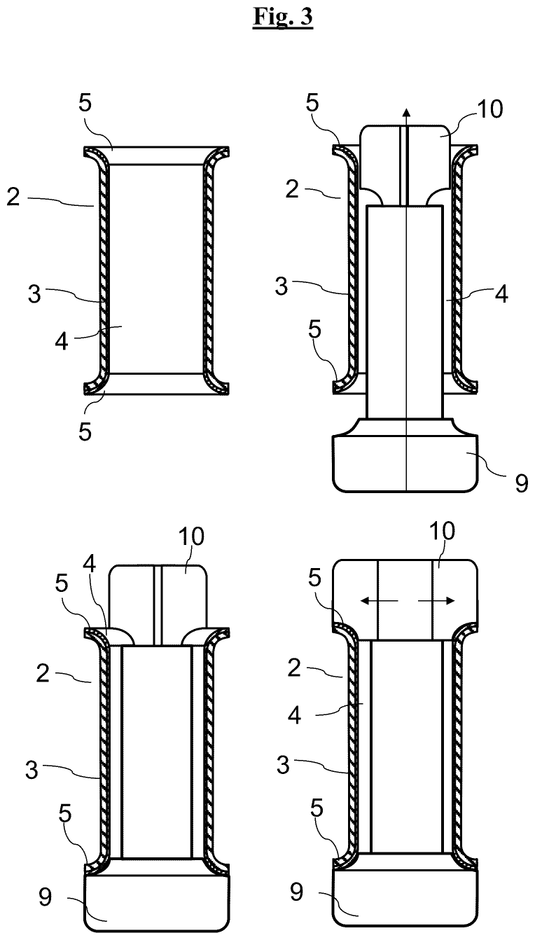

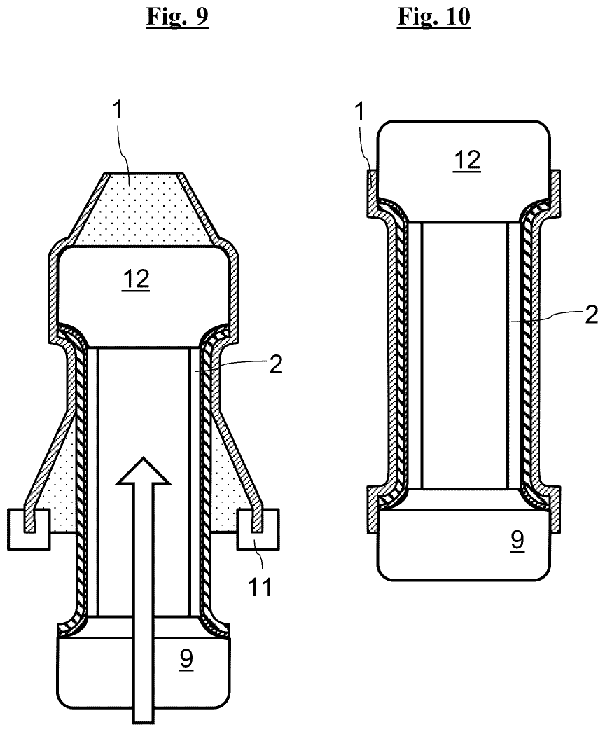

FIGS. 3 to 11 do not directly relate to the core task of pressing the projecting regions 6 on but may be regarded as preliminary steps in a preferred process or a preferred plant.

FIG. 3 shows a first variant of a holding device 9 for hollow articles 2, which may be moved through a machine for installing sleeves 1 with the hollow articles 2.

The holding device 9 may perform two functions. Firstly, it may have a shape which corresponds to the shape of objects previously provided with sleeves using known devices. Such objects, in particular bottles, have a conical top region which goes first when the object is pushed into the sleeve. Accordingly, the holding device 9 has a top end which surmounts the hollow article 2 at the time of insertion into the sleeve 1, which top end comprises a tapered, in particular conical or rounded, region. Stretching the sleeve 1 is thus advantageously done by the holding device 9 and not the bulge 5 of the hollow article 2.

The second task of the holding device 9 is stabilising the hollow article 2 from the inside, in particular in the region of the bulge 5.

In a variant embodiment, the holding device 9 may be present as a packaging dummy, meaning that rather than a known object such as a bottle, a packaging dummy comprising the holding device 9 and the hollow article 2 present thereon is moved through the plant for installing the sleeve 1. The packaging dummy is picked up by the plant in a holder like a conventional object to be packaged and moved through the plant. The result is a packaging dummy according to FIG. 5 or FIG. 10. When the holding device 9 is removed from the hollow article 2, the projecting regions 6 contract, so that the state of FIG. 1 is achieved, so that the projecting regions 6 can be pressed on as described before. A new hollow article 2 may then be placed in the now free holding device 9 and the holding devices 9 may be moved through the plant for installing the sleeve 1 in a cycle.

Preferably, removal of the holding device 9 takes place once the hollow article 2 is held in the holder 7 of the machine for installing the projecting regions 6.

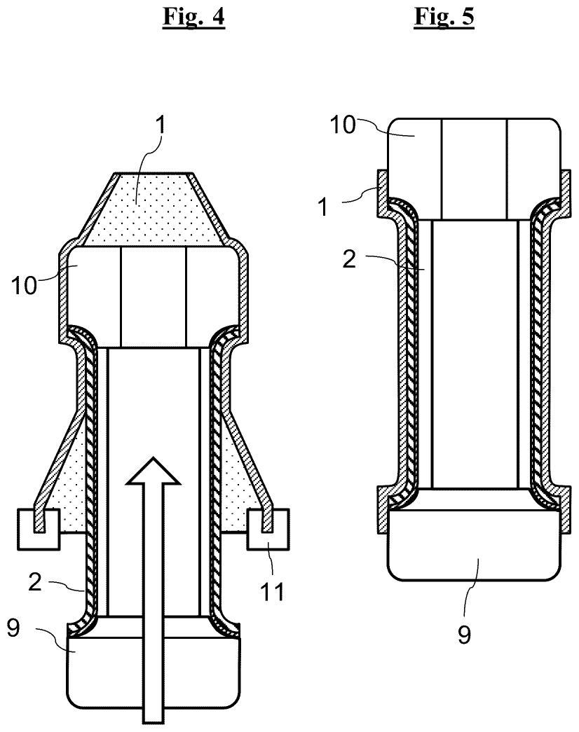

However, the holding device 9 may also be part of the plant for installing the sleeve 1 and thus be moved in a cycle in the plant. The holding device 9 then picks up a hollow article 2 to be sleeved and moves it into the sleeve 1. This is usually done by the sleeve 1 being held at one end by multiple gripping elements 11 and stretched and the object to be sleeved being moved into the sleeve 1 from this end. Once the sleeve 1 is in its desired position, the gripping elements 11 may be opened or moved away and pulled downwards and out of the sleeve 1. Alternatively, the gripping elements 11 may be opened and moved away while the object with the sleeve 1 adhered thereto is moved further up until the sleeve 1 exits the gripping elements 11 and contacts the object. The gripping elements 11 are depicted as very short in FIGS. 4, 8 and 9. They may be substantially longer in known devices to stretch the sleeve 1 over a larger subregion or across its entire length. The interior perimeter of the stretched sleeve 1 may in each region be larger than the exterior perimeter of the bulges 5, so that the sleeve 1 does not get into contact with the hollow article 2 when being pulled over, only when the gripping elements 11 are removed from the sleeve 1. The gripping elements 11 may be present as finger-shaped holding elements 22 as illustrated by FIG. 12.

The holding device 9 of FIGS. 3 to 6 comprises a radially adjustable head 10 made up of at least two elements. The holding device 9 may be moved from the first bulge 5 into the hollow article 2 by moving the multiple elements radially inwards. Once the adjustable head has reached the second bulge 5, the multiple elements may be moved apart radially outwards until they contact the inside of the second bulge 5. At the other end, the holding device 9 may have a solid head that corresponds to the shape of the first bulge 5, which contacts the inside of the first bulge 5. Preferably, the adjustable head 10 and the solid head each have a cylindrical region which surmounts the respective bulge 5 in a longitudinal direction of the hollow article 2. In the case of the adjustable head 10, the cylindrical region is permanently present and is formed by the respective cylindrical partial surfaces of the individual elements of the adjustable head 10. The exterior perimeter of the cylindrical region may be greater than or equal to the exterior diameter of the exterior edge of the bulge 5. Thereby, no or at least less strain is put on the second bulge 5 in particular in the longitudinal direction of the hollow article 2.

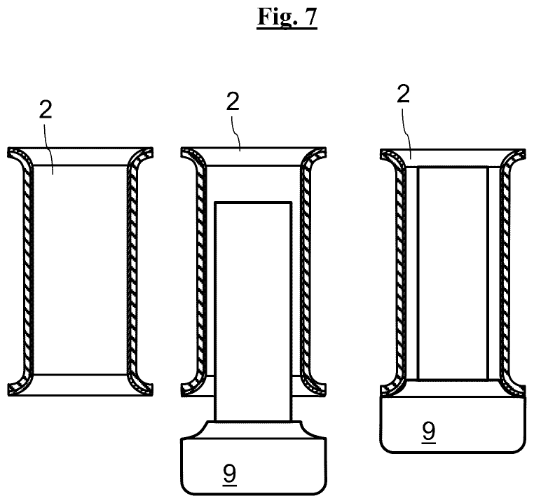

The same can be achieved by a two-part holding device 9 as illustrated in FIGS. 7 to 11. The loose head 12 may be inserted into the hollow article 2 from the other end. The loose head 12 might be present in a guided manner in the other part of the holding device 9 or have a releasable connection thereto (both not shown).

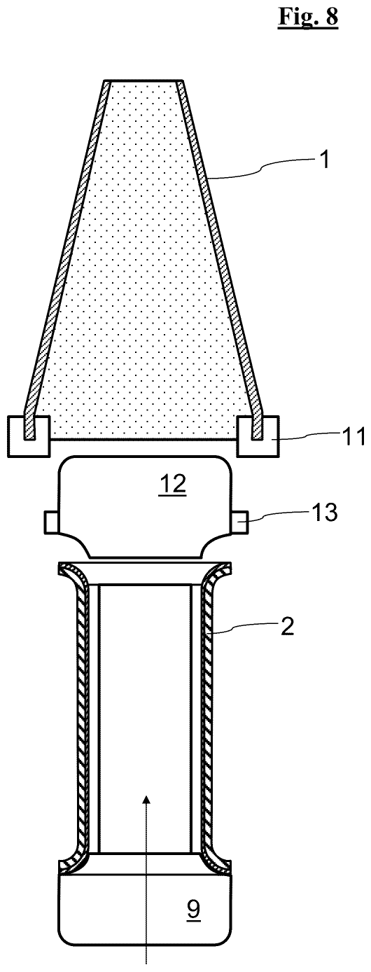

When such a holding device 9 is included in a plant for installing sleeves 1, the hollow articles 2 may first be placed on a holder which is the first part of the holding device 9. As illustrated by FIG. 8, the loose head 12 may be held above said holder by a gripping element 13, whereby it reaches the hollow article 2 when the holder with the hollow article 2 is moved up and handed over to the holder by the gripping element 13. The loose head 12 is then moved through the sleeve 1 as part of the holding device 9 until the state of FIG. 10 is achieved. The loose head 12 may then be elevated and provided in the position illustrated by FIG. 8 for reuse with a hollow article 2 to be sleeved later. After removing the loose head 12 and the other part of the holding device, the state of FIG. 1 is reinstated, so that the hollow article 2 can be processed in the machine for installing the projecting regions 6.

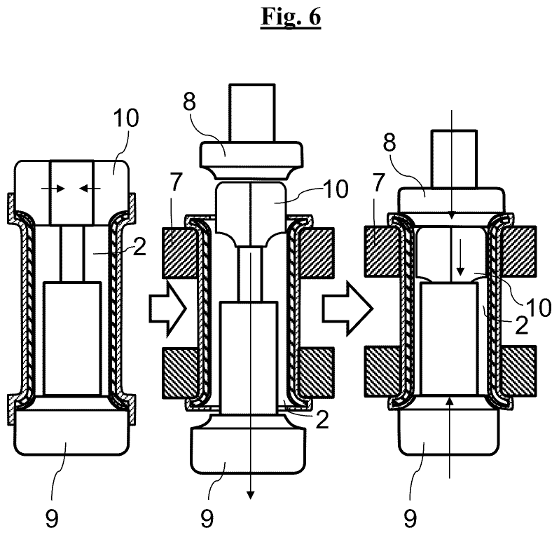

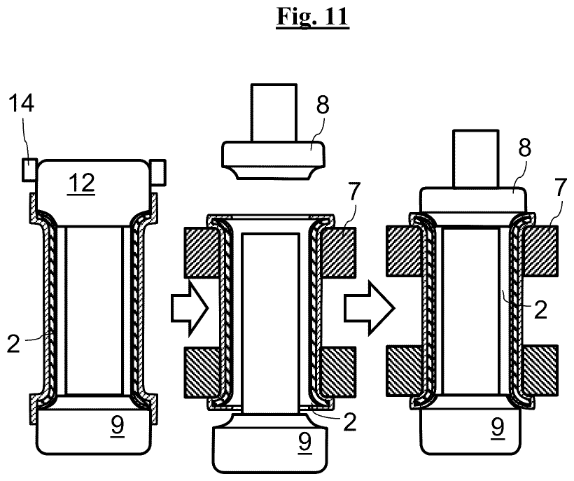

Finally, FIGS. 6 and 11 illustrate variants in which installing the projecting regions 6 is done on the holding devices 9. Since this requires a heating action to weld the sleeve 1 to the barrier layer 4 through the holding devices 9, the complexity of the machine is increased. The lower part of the holding device 9 may be executed as a pressing element 8, while the other end will probably require its own pressing element 8, since heating action through the movable head 10 or the loose head 10 would cause a device of even greater complexity.

As illustrated, the movable head 10 may be lowered into the hollow article 2 following the radial contraction to make space for the pressing element 8. Lowering the movable head 10 may, for example, be in a passive manner by the pressing force of the pressing element 8. The loose head 12 may alternatively be removed earlier by a gripping element 14.

The lower, solid head of the holding device 9 is briefly moved out of the hollow article 2 to allow the projecting region 6 of the sleeve 1 to adopt an inward shape. The lower, solid head may then be moved back into the hollow article 2 so as to weld on the projecting region 6 at the same time as the pressing element 8.

Naturally, it is also possible to remove the lower, solid head of the holding device 9 and provide a second, separate pressing element 8 instead.

FIG. 12 illustrates another variant of a holding device 9. It is frictionally engaged inside the hollow article 2, for example by it comprising radially extendable elements or being inflatable.

The bulges 5 may optionally also be supported from the inside by radially extendable elements or radially inflatable regions. When the sleeve 1 is installed, it is pulled directly over the bulges 5, so that the state of FIG. 1 is directly achieved upon releasing the gripping elements 11 and the projecting regions 6 can be installed.

As further illustrated in FIG. 12, devices for installing a sleeve 1 are known in prior art, wherein long, finger-shaped holding elements 22 stretch the sleeve 1 and keep it open until it ends up entirely over the article to be packaged or until the sleeve 1 is in its required position. The holding elements 22 are then pulled out of the sleeve 1, potentially be assisted by blowing in air. When the holding elements 22 are extracted, the sleeve 1 contacts the article to be packaged, which in the present case is the hollow article 2.

It is noted that the machine for installing the sleeve 1 may generally be one known in prior art, in particular regarding the elements for stretching and pulling over the sleeve 1 and all elements for delivering the sleeve tube and separating individual sleeves 1 from this sleeve tube. The mechanism causing the relative movement between sleeve 1 and the article to be packaged may be present as known in prior art.

What is different, however, is the way the hollow article 2 is held, since it is held on its inside at the time of installing the sleeve 1, which is not possible with a closed article such as a beverage bottle.

The sleeve 1 is placed over the hollow article 2 such that it surmounts the hollow article 2 at both ends. The length of the projecting areas 6 of the sleeve 1 is preferably between 3 mm and 6 mm. Preferably, the sleeve 1 surmounts the hollow article 2 by the same amount at both ends. Placement of the sleeve 1 must thus by particularly accurate.

The hollow article 2 is preferably in a predefined position in its longitudinal direction on the holding device 9. Preferably, the hollow article 2 also has a predefined orientation on the holding device, i.e. with a predefined perimeter position of a feature of the hollow article such as a thicker area and/or the position of a seam of one of the hollow article's layers. The holding device 9 fixates the hollow article 2 preferably in its longitudinal direction, including against rotation around its longitudinal axis.

Holding the hollow article 2 on its inside is advantageous since it allows to stabilise the cylindrical shape of the hollow article 2 and to dry the hollow article 2 on its outside, at least until the sleeve 1 is installed.

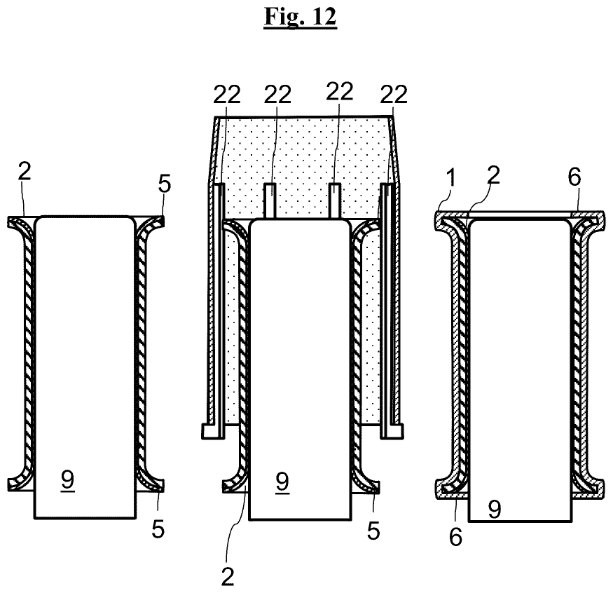

FIG. 13 schematically illustrates a variant embodiment in which the hollow article 2 is held in the device for connecting the projecting regions 6 of the sleeve 1 to the barrier layer 4 from inside the hollow article 2. Connecting is at the end facing away from the holding device, for example by the pressing element 8 shown. The hollow article 2 may then be elevated from the holding device 9 and turned and put back onto the holding device 9 or another holding device 9, whereupon the sleeve is connected to the barrier layer at the second end in an equal or different manner. Alternatively, a handover to a second holding device 9 may take place, which protrudes into the hollow article 2 from the opposite end, so that the second end may be processed without turning the hollow article 2. In a variant embodiment, a pressing element 8 may comprise a holding device which protrudes onto the inside of the hollow article 2, so that the pressing element 8 takes over the hollow article from the holding device 9 shown. The holding device 9 shown may then be moved out of the hollow article 2 and a second pressing element 8 moved into the hollow article 2 from this end.

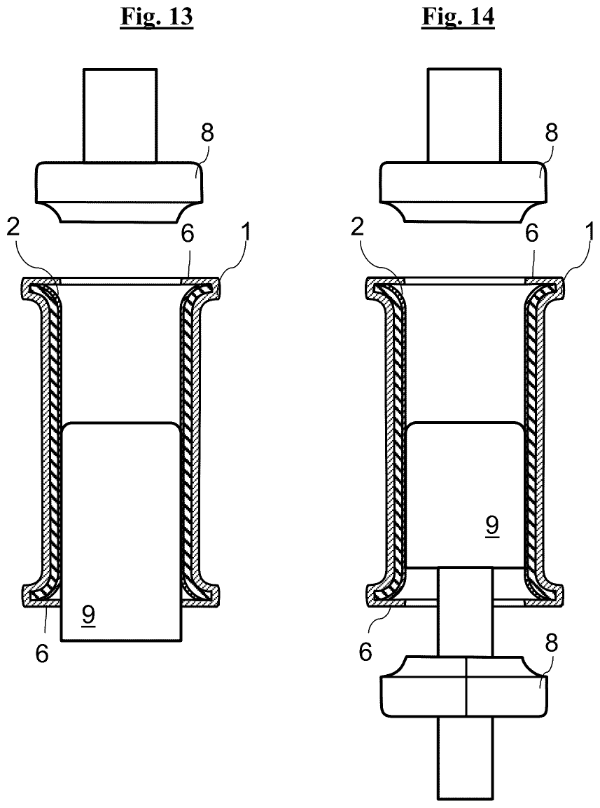

FIG. 14 shows a second variant embodiment in which the hollow article 2 is held in the device for connecting the projecting regions 6 of the sleeve 1 to the barrier layer 4 from inside the hollow article 2. As shown, processing the two ends of the hollow article 2 may occur at both ends at the same time in this case as well. It may be facilitated by an annular pressing element 8 around the holding device 9 being present and movable towards the hollow article 2. Alternatively, the holding force of the holding device 9 may be lower than the pressing force of the opposite pressing element 8, so that the upper pressing element 8 presses the hollow article 2 against the lower pressing element 8. The holding force of the holding device 9 may be reduced before or while pressing the upper holding element 8 or removed entirely, for example by adjusting adjustable or inflatable elements of the holding device radially inward and/or reducing their pressing pressure. Lowering the hollow article 2 onto the lower pressing element 8 may be by using the force of gravity, wherein the gravitational force of the hollow article 2 may also be sufficient to press the sleeve 1 onto the barrier layer 4.

In all variant embodiments, the holding device 9 or the holder 7 may be designed to execute a movement of the hollow article 2 in its longitudinal direction, so that the holding device 9 or the holder 7 presses the hollow article 2 against a pressing element 8.

As illustrated by FIG. 14, the lower pressing element 8 may be present in the shape of two half-shells, so that it can be placed around the holding device 9 at any time. This means that the pressing element 8 does not have to be constantly moved along with the holding device 9.

In case the sleeve 1 is pressed onto the barrier layer by compressed air, ring nozzles may be used to have all regions of the sleeve 1 press on at the same time. Alternatively, a series of nozzle may be stationary at either or both ends of a transport route, wherein the hollow article 2 is rotated on the holding device about its longitudinal axis.

In a variant embodiment, a holding device 9 is used both in the machine for installing the sleeve 1 and in the machine for connecting the projecting regions 6 to the barrier layer 4, so that each hollow article 2 is moved through both machines using a single holding device 9.

In another variant embodiment, there is a handover between the two machines from a first holding device 9 to a second holding device 9.

Less preferably, the hollow articles 2 may also be stored intermediately or delivered to a buffer system between being processed by the two machines.

In a preferred variant, the machine for installing the sleeve 1 follows a machine for winding the individual layers of the hollow article into a continuous tube, which machine comprises a device for separating the individual hollow articles 2 and is followed by a machine for shaping the two bulges 5, wherein the said machines preferably cooperate in a continuous process. If required for drying, intermediate storage of the separated individual hollow articles 2 and/or extension of the transport path of a transport line may be done, for example by a buffer tower, between the machine for shaping the two bulges 5 and the machine for installing the sleeve 1 or even prior to the machine for shaping the two bulges 5.

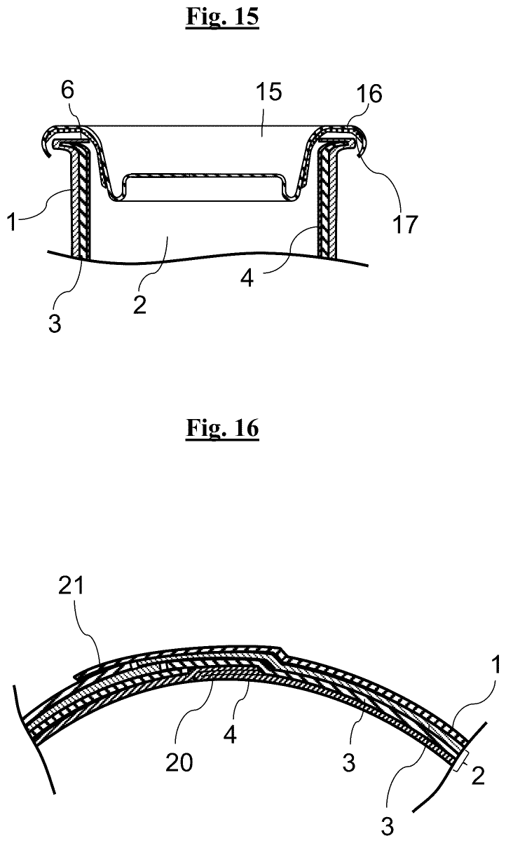

In a variant embodiment, as previously mentioned and as illustrated by FIG. 15, the inwardly protruding regions 6 of the sleeve 1 may be connected to the barrier layer 4 only when placing the sealing elements 15. The sealing elements 15 are preferably present as can lid and can bottom, which are known from aluminium cans, for example. When placing a sealing element 15, the edge region 16 of the sealing element 15 is contacted with the outwardly bulged hollow article edge and the two edge regions are crimped together. By said crimping, the edge region 16 of the sealing element 15 and the edge region of the hollow article 2 are mechanically pressed together to create a tight connection.

Said mechanical crimping presses the inwardly protruding region 6 of the sleeve 1 onto the barrier layer 4. In a variant embodiment, this mechanical connection of the sleeve 1 to the barrier layer 4 by crimping the sealing element 15 is the only one.

In another variant embodiment, additional welding of the sleeve 1 to the barrier layer 4 is performed. This may be by installing a heated sealing element 15 or by subsequent heating action, for example by ultrasound, induction, heat irradiation, hot air, infrared light, UV light or laser.

If the sealing element 15 has a plastic coating 17 on its inside or only in the region of the flange, this coating may also be welded to the sleeve 1.

As is known from WO2022219176A1, the hollow article 2 may have a thicker area at one point of its perimeter. This thicker area results from the barrier layer 4 being a wound layer, so that this layer's seam does not require sealing. Preferably, the seam runs straight and in a longitudinal direction of the hollow article. Possible variants for sealing the seam may be taken from WO2022219176A1. The folding seam 20 shown (“anaconda seam”) is a preferred shape of seam. The thicker area may continue from the barrier layer 4 all the way to the outside of the hollow article 2. However, the thicker area may also be present on the inside of the hollow article 2.

The sleeve 1 also typically has a perimeter region having a thicker area 21, with a single overlap of the material of the sleeve 1. The thicker area 21 runs straight in a longitudinal direction of the sleeve 1.

It is preferred for the installment of the sleeve 1 to the hollow article 2 to be done at controlled orientation, so that the thicker area of the jacket of the hollow article 2 and the thicker area 21 of the sleeve 1 are in different perimeter regions.

As illustrated by FIG. 16, the thicker area 21 of the sleeve 1 may adjoin the thicket area of the hollow article 2.

In another variant embodiment, the thicker area 21 of the sleeve 1 may be present in any position beyond the thicker area of the hollow article 2. It is even possible albeit not required that the thicker areas are diametrically opposite each other on the perimeter of the hollow article 2. Positioning of the thicker area 21 of the sleeve 1 does not be particularly exact as long as it is in an angular range outside the angular range of the thicker area of the hollow article 2.

The ticker area of the hollow article 2 and the thicker area 21 of the sleeve 1 run in a longitudinal direction of the hollow article 2. Therefore, the respective thicker areas do not intersect.

1-17. (canceled)

18. A method of placing an elastic sleeve on a hollow article open at both ends, the elastic sleeve being longer than a distance between two opposite open ends of the hollow article and the elastic sleeve having a smaller perimeter in an unstretched state than the two opposite open ends, the method comprising:
holding from an inside the hollow article within a machine for installing the elastic sleeve;
stretching the elastic sleeve by a spreading action at least at an end of the elastic sleeve facing the hollow article;
placing the elastic sleeve over the hollow article in a longitudinal direction of the hollow article until the elastic sleeve surmounts a jacket surface of the hollow article in the longitudinal direction at the two opposite open ends;
removing the spreading action, whereupon two edges of the elastic sleeve which surmount the hollow article protrude inwards substantially in planes defined by opening edges at the two opposite open ends of the hollow article;
pressing, subsequently to the removing, the two edges of the elastic sleeve onto an interior surface of the hollow article; and
connecting the two edges of the elastic sleeve to the hollow article.

19. The method of claim 18, wherein the hollow article is cylindrical and has at the two opposite open ends an outwardly bulged edge region.

20. The method of claim 19, wherein the outwardly bulged edge region at the two opposite open ends comprises two opposite edge regions running outwards alongside a radius between which a cylindrical jacket section of the hollow article extends.

21. The method of claim 18, wherein an interior jacket surface of the hollow article is formed by a barrier material which extends across a height of the hollow article up to the two opening edges and in that an exterior jacket surface of the hollow article is made of paper or cardboard material.

22. The method of claim 18, wherein:
multiple hollow articles are simultaneously moved through the machine for installing the elastic sleeve;
each hollow article of the multiple hollow articles is present on a holding element which contacts the jacket surface of the hollow article on the inside; and
after installing the elastic sleeve, the multiple hollow articles are transported further on the holding element to a device which presses one or both of the inwardly protruding edges of the elastic sleeve onto the interior surface of the hollow article.

23. The method of claim 22, further comprising, before or while the inwardly protruding edges of the elastic sleeve are pressed onto the interior surface of the hollow article, heating the elastic sleeve and an interior jacket surface of the hollow article;
wherein the elastic sleeve and the interior jacket surface are made of plastic and welded together.

24. The method of claim 18, wherein pressing at least one of the two inwardly protruding edges of the elastic sleeve is done by installing a sealing element which seals an opening of the hollow article.

25. The method of claim 18, wherein the hollow article is supported from the inside by a holding element across its cylindrical interior jacket region while the elastic sleeve is being installed.

26. The method of claim 19, wherein the hollow article is supported from the inside by a holding element in the outwardly bulged edge region of the hollow article while the elastic sleeve is being installed.

27. The method of claim 18, wherein:
stretching the elastic sleeve is performed by multiple spreading elements which protrude onto the inside of the elastic sleeve;
the spreading elements contact the elastic sleeve on the inside across a length thereof which equals at least half the length of the hollow article; and
the multiple spreading elements are present between the elastic sleeve and the hollow article while the elastic sleeve is placed and wherein they are extracted from between the hollow article and the elastic sleeve when the elastic sleeve is at its desired position on the hollow article.

28. The method of claim 18, wherein, while at least one of the two edges of the elastic sleeve protruding inwards is pressed onto the interior surface of the hollow article and connected, a counterpressure is applied on an outside of the hollow article.

29. The method of claim 28, wherein the counterpressure is applied to the outwardly bulged edge region of the hollow article.

30. The method of claim 28, wherein the counterpressure is applied by a holder which encompasses the hollow article.

31. The method of claim 29, wherein the counterpressure is applied by an expandable element which contacts an exterior edge region of the hollow article only in an expanded state.

32. The method of claim 31, wherein the expandable element is one of inflatable and pumpable.

33. The method of claim 18, wherein installing the elastic sleeve to the hollow article is performed at a controlled orientation, so that a thicker area of the jacket of the hollow article and a thicker area of the elastic sleeve lie in different perimeter regions.

34. The method of claim 18, wherein pressing at least one of the two edges of the elastic sleeve protruding inwards onto the interior surface of the hollow article is performed using a transparent stamp and in that a laser beam is directed onto the regions of the elastic sleeve and the interior surface of the hollow article to be connected through the transparent stamp.

35. A device for installing an exterior sleeve on an inside of a hollow article open at both sides, the exterior sleeve being placed over the hollow article in a longitudinal direction thereof, the exterior sleeve surmounting a jacket surface of the hollow article at both open ends in the longitudinal direction, the device comprising:
holding devices or holders each for holding one open hollow article; and
pressing elements for pressing the exterior sleeve onto the inside of the hollow article at at least one end of the open hollow article;
wherein a relative movement between the pressing elements and the holding elements or holders can be executed through the device.

36. The device of claim 35, the two edges of the exterior sleeve which surmount the hollow article protrude inwards substantially in planes defined by opening edges at the two opposite open ends of the hollow article.

37. The device of claim 35, further comprising welding means for welding the exterior sleeve to the inside of the hollow article that is open at both ends.

38. The device of claim 35, further comprising means for applying a counterpressure onto an outside of the hollow article opposite the pressing elements.
